(19) United States
(12) Patent Application Publication
(10) Pub. No.: US 2001/0049030 A1
(43) Pub. Date: Dec. 6, 2001

(54) ORGANIC ELECTROLUMINESCENCE (EL) DEVICE

(76) Inventors: HIROYUKI OKADA, TOYAMA-SHI (JP); SHIGEKI NAKA, TOYAMA-SHI (JP); HIROYOSHI ONNAGAWA, TOYAMA-SHI (JP); MORIMITSU WAKABAYASHI, TOYOMA (JP); SHIGERU FUKUMOTO, TOYAMA (JP); TETSUYA TANBO, TOYAMA (JP)

Correspondence Address: RANKIN, HILL, PORTER & CLARK, LLP, 700 HUNTINGTON BUILDING, 925 EUCLID AVENUE, CLEVELAND, OH, 44115-1405, US

(21) Appl. No.: 09/193,500

(22) Filed: Nov. 17, 1998

(30) Foreign Application Priority Data
Nov. 20, 1996 (JP) 326062/1996
Nov. 18, 1997 (JP) 333653/1997

(51) Int. Cl. H05B 33/00

(52) U.S. Cl. 428/690; 428/917; 313/504; 313/506; 313/505; 257/98; 257/88; 257/89; 257/99; 427/66

(57) ABSTRACT

An organic EL device capable of preventing a deterioration in luminous section and increasing an effective area of a luminous section and current gain thereof. The organic EL device includes at least one first electrode made of a transparent electrode material, at least one luminous section made of an organic EL material and formed on the first electrode, and at least one second electrode formed on the luminous section. The luminous section is arranged on the first electrode so that the first electrode has an annular upper surface portion which is not covered with the luminous section left on an upper surface thereof in a manner to surround the luminous section. The second electrode is formed so that the luminous section has an annular upper surface portion which is not covered with the second electrode left on an upper surface thereof in a manner to surround the second electrode. The organic EL device also includes at least one insulating side wall structure made of an insulating material, formed into an annular shape and arranged so as to cover the annular upper surface portion of the first electrode, an outer peripheral side surface of the luminous section, the annular upper surface portion of the luminous section and an outer peripheral side surface of the second electrode. The organic EL device also includes an insulating protective layer formed of an insulating material so as to cover the insulating side wall structure and an exposed portion of the first electrode and provided with holes through which an upper surface portion of the second electrode is exposed and at least one third electrode formed on the insulating protective layer and connected to the second electrode through the holes of the insulating protective layer.

### BACKGROUND OF THE INVENTION

This invention relates to an organic electroluminescence (hereinafter referred to as “EL”) device, and more particularly to an organic EL device used for a plane light source, a plane display device or the like and a method for manufacturing the same.

Recently, H. Nakada and T. Tohma, Inorganic and Organic Electroluiminescence (EL96 Berlin), (edited by R. H. Mauch and H. E. Gunlich, Wissenschaft und Technik Verlag, Berlin) pp 385-390 (1996), reported an organic EL device having 256×64 pixels, which is manufactured by working or processing in which a wet process is not employed. The organic EL device thus manufactured is reported to exhibit luminous efficiency of 1.21. m/W, luminance of 100 cd/m², a contrast ratio of 100:1, a lifetime over 10,000 hours and power consumption of 0.5 W.

Hosokawa et al, International Conference on Eectroluminescence of Molecular Materials and Related Phenomena, 21-I-01, reported a high-definition organic EL display of a blue luminous color having a size of 5 inches and 320×240 pixels, which is manufactured by techniques similar to those described above. The organic EL display is reported to exhibit performance of a lifetime of 20,000 hours, the number of gradation of 256, luminance of 100 cd/m², a response speed of 1 μs, a thickness of 2 mm and a weight of 80 g.

Also, Hosokawa et al, SID ′97 Digest, pp 1073-1076 (1997), reported that a combination of color conversion layers provides color display.

C. C. Wu, Applied Rhysics Letters, 69(21), pp 3117-3119 (1996), succeeded in integration of a three-color organic EL device by arranging non-luminous sections around luminous sections, subjecting an organic material layer to processing by etching using an upper electrode layer as a mask and then surrounding a periphery of the device with electrodes. The techniques are reported to permit use of the electrode layer as a, protective layer to prevent electric short-circuit, leakage, a, deterioration in the device due to exposure thereof, dissolution of the device by a solvent. Unfortunately, the device reported substantially fails to display an image at ultra,-high definition, is deteriorated in stability thereof, fails to exhibit uniform luminescence and renders application of photolithography thereto difficult. Also, it leads to a failure to readily match components of the device with each other or a failure in self-matching.

In general, an organic EL material is readily changed in, properties due to heat or chemicals and renders formation of a pattern by etching or the like difficult or troublesome. Thus, the prior art employs mask deposition for formation of a desired pattern. However, the mask deposition has a, problem of causing atoms for deposition to be turned into a rear side of a, mask depending on adhesion of the mask and a direction of the deposition. Thus, the mask deposition renders formation of a pattern of 1 mm or less highly difficult.

### SUMMARY OF THE INVENTION

The present invention has been made in view of the foregoing disadvantage of the prior art.

Accordingly, it is an object of the present invention to provide an organic EL device which is capable of preventing a deterioration in luminous section.

It is another object of the present invention to provide an organic EL device which is capable of satisfactorily accomplishing self-matching thereof.

It is a further object of the present invention to provide an organic EL device which is capable of exhibiting luminous display at high quality.

It is still another object of the present invention to provide an organic EL device which is capable of permitting a fine luminous section to be formed by lithography techniques.

It is yet another object of the present invention to provide an organic EL device which is capable of increasing an effective area of a luminous section.

It is a still further object of the present invention to provide a method for manufacturing an organic EL device which is capable of providing an organic EL device attaining the above-described objects.

In accordance with one aspect of the present invention, an organic EL device is provided. The organic EL device includes at least one first electrode made of a transparent electrode material such as indium tin oxide (ITO) or the like, at least one luminous section made of an organic EL material and formed on the first electrode, and at least one second electrode formed on the luminous section. Typically, a plurality of the first electrodes constitute a first wiring pattern. In this instance, the first electrodes for the first wiring pattern, are juxtaposed to each other on a front surface of an insulating substrate made of glass, quartz, resin or the like while being spaced from each other at predetermined intervals. The luminous section is arranged on the first electrode so that the first electrode has an annular upper surface portion which is not covered with the luminous section left on an upper surface thereof in a manner to surround the luminous section. The luminous section is made of an organic EL material which permits suitable conduction of electrons and positive holes when it is impregnated with the electrons and holes by the first and second electrodes and which has internal luminous properties. The luminous section is formed by etching. The second electrode is formed so that the luminous section has an annular upper surface portion which is not covered with the second electrode left on an upper surface thereof in a manner to surround the second electrode. The organic EL device also includes at least one insulating side wall structure made of an insulating material, formed into an annular shape and arranged so as to cover the annular upper :surface portion of the first electrode, an outer peripheral side surface of the luminous section, the annular upper surface portion of the luminous section and an outer peripheral side surface of the second electrode. Also, the organic EL device also includes an insulating protective layer formed of an insulating material so as to cover the insulating side wall structure and an exposed portion of the first electrode and provided with at least one hole through which an upper surface portion of the second electrode is exposed and at least one third electrode formed on the insulating protective layer and connected to the second electrode through the bole of the insulating protective layer. In a preferred embodiment of the present invention, a second wiring pattern is constituted of a plurality of the third electrodes.

In the present invention, first a device is formed on the first electrode of a flat shape, to thereby eliminate non-uniformity of both luminescence of the device and a current path.

Also, in the present invention, the insulating side wall structure is arranged so as to cover the luminous section and second electrode, to thereby increase current gain and effectively prevent a deterioration in luminous section. Such advantages are promoted when, the insulating side wall structure is constituted by a first insulating side wall arranged so as to cover the outer peripheral side surface of the second electrode and the annular upper surface portion of the luminous section and a second insulating side wall arranged so as to cover an outer peripheral side surface of the first insulating side wall and the annular upper surface portion of the first electrode. The annular upper surface portion of the luminous section covered by the first insulating side wall acts as a non-luminous portion which does not contribute to luminescence. Arrangement of such a non-luminous portion around the luminous section leads to an increase in current gain. The second insulating side wall thus covers the outer peripheral side surface of the luminous section and the annular upper surface portion of the first electrode, to thereby prevent an organic material for the luminous section from being deteriorated by chemicals or gas used for formation of the first electrode by etching.

Formation of a plurality of the first electrodes into the first wiring pattern by etching and formation of a plurality of the luminous sections by etching permit the first electrodes, luminous sections and second electrodes to be accurately matched or registered with each other, leading to an increase in area of occupation of the luminous sections or density thereof. This results in maximizing an area occupied by the luminous section in the organic EL device.

Techniques of forming the insulating side wall structure are commonly used in fine processing of a semiconductor. More specifically, the insulating side walls each are formed into a width as fine as 1 μm. This permits formation of an hyperfine luminous device having luminous sections each formed into a size as small as 100 μm.

An intervening layer such as a color filter described hereinafter may be interposedly arranged between the transparent insulating substrate and the first electrode. Such arrangement keeps the first wiring pattern which is constituted of the first electrodes from being arranged on the transparent insulating substrate. In such a case, the first electrodes are formed on a substrate removable in the subsequent step rather than on the transparent insulating substrate, resulting in providing an essential part of the device. Then, the removable substrate is removed, followed by bonding between the transparent insulating substrate and the essential part of the device through the intervening layer.

The first wiring pattern may be formed into an any desired shape. In general, a stripe-like electrode array pattern in which a plurality of the first electrodes of an elongated shape are juxtaposed to each other while being spaced from each other at predetermined intervals is employed as the first wiring pattern. In this instance, the second wiring pattern may be likewise constituted by a stripe-like electrode array pattern wherein a plurality of the third electrodes are juxtaposed to each other while being arranged so as to intersect the first electrodes and spaced from each other at predetermined intervals.

The above-described construction of the present invention may be applied to a color display device. In such a case, a color filter is arranged on a rear surface of the insulating substrate by way of example. The color filter includes a plurality of wavelength conversion sections arranged in a manner to correspond to a plurality of the luminous sections and constructed so as to convert incident light of predetermined luminous wavelength intensity distributions emitted from the luminous sections into the three primary colors or colors similar thereto.

Also, the present invention may be constructed so as to emit the three primary colors directly from a plurality of the luminous sections. For this purpose, the first electrodes are classified into first to third groups. The first group of first electrodes includes two first electrodes intermediately arranged and is formed thereon with a plurality of the luminous sections, which are constructed so as to emit one of the three primary colors. The second group of first electrodes includes two first electrodes intermediately arranged and is formed thereon with a plurality of the luminous sections, which are constructed so as to emit another one of the three primary colors. The third group of first electrodes includes two first electrodes intermediately arranged and is formed thereon with a plurality of the luminous sections, which are constructed so as to emit another the other one of the three primary colors.

In accordance with another aspect of the present invention, a method for manufacturing an organic EL device is provided. The method includes the step of forming a first electrode layer for a plurality of first electrodes on a front surface of a transparent insulating substrate. The first electrode layer is made of a transparent electrode material. Then, a luminous material layer is formed on the first electrode material layer. The luminous layer is made of an organic EL material. Then, a plurality of second electrodes of a predetermined configuration are formed on the luminous material layer while being spaced from each other at predetermined intervals. Subsequently, a first insulating material layer is formed on the luminous material layer so as to cover the second electrodes. The first insulating material layer is made of an insulating material. Also, the method includes the steps of removing the insulating material layer so as to leave a plurality of first insulating side walls surrounding the second electrodes, subjecting the luminous material layer to etching so as to leave a plurality of luminous sections below the second electrodes and first insulating side wails, and forming a second insulating material layer so as to cover the second electrodes, first insulating side walls and luminous sections. The second insulating material layer is made of an insulating material. The method further includes the steps of removing the second insulating material layer so as to expose an upper surface of each of the second electrodes and leave a plurality of second insulating side walls surrounding an outer peripheral surface of each of the first insulating side walls and an outer peripheral side surface of each of the luminous sections, subjecting the first electrode material layer to etching so as to form a first wiring pattern constituted of a plurality of the first electrodes juxtaposed to each other below the luminous sections and second insulating side walls, and forming an insulating protective layer on the front surface of the insulating substrate. The insulating protective layer is made of an insulating material and formed with a plurality of holes through which the upper surface of the second electrodes is exposed. Lastly, a second wiring pattern is formed on the insulating protective layer in a manner to connect the second wiring pattern to the second electrodes through the holes of the insulating protective layer.

### BRIEF DESCRIPTION OF THE DRAWINGS

These and other objects and many of the attendant advantages of the present invention will be readily appreciated as the same becomes better understood by reference to the following detailed description when considered in connection with the accompanying drawings; wherein:

FIGS. 1A to 1F each are a schematic sectional view showing each of steps in manufacturing of a first embodiment of an organic EL device according to the present invention;

FIGS. 2A to 2D each are a schematic sectional view showing each of further steps which are executed subsequently to the step shown in FIG. 1F in manufacturing of a first embodiment of an organic EL device according to the present invention;

FIGS. 3A and 3B each are a schematic view showing a pattern of a photomask used in the manufacturing steps shown in FIGS. 1A to 2D;

FIG. 4 is a fragmentary sectional view showing a second embodiment of an organic EL device according to the present invention;

FIG. 5 is a fragmentary sectional view showing a third embodiment of an organic EL device according to the present invention;

FIGS. 6A to 6E each are a schematic sectional view showing each of steps in manufacturing of a fourth embodiment of an organic EL device according to the present invention;

FIGS. 7A to 7E each are a schematic sectional view showing each of further steps which are carried out subsequently to the step shown in FIG. 6E in manufacturing of a fourth embodiment of an organic EL device according to the present invention;

FIG. 8 is a graphical representation showing current density-voltage characteristics of an organic EL device manufactured by the steps shown in FIGS. 1A to 2D; and

FIG. 9 is a graphical representation showing luminescence-current density characteristics of an organic EL device manufactured by the steps shown in FIGS. 1A to 2D.

### DETAILED DESCRIPTION OF THE PREFERRED EMBODIMENTS

Now, an organic EL device according to the present invention will be described hereinafter with reference to the accompanying drawings.

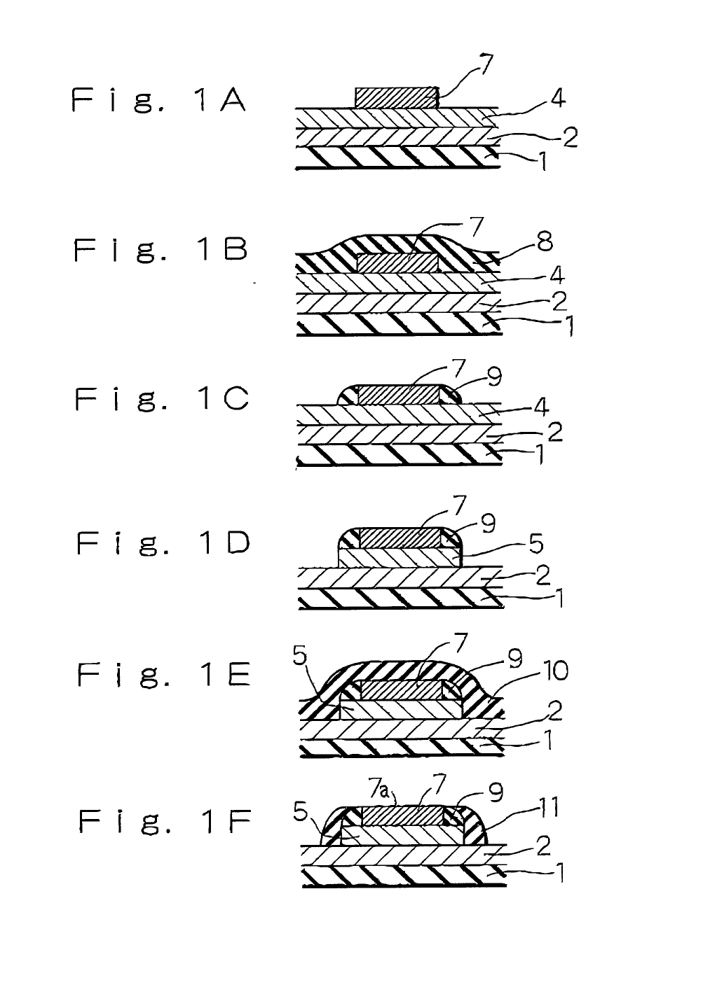

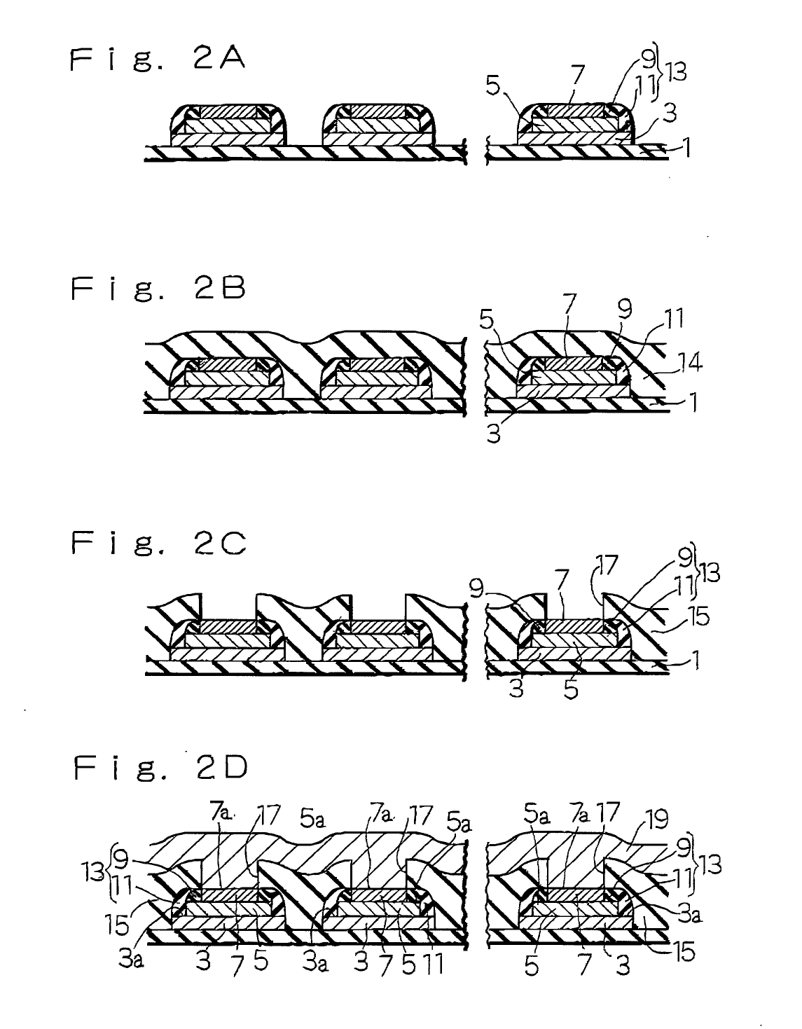

Referring first to FIGS. 1A to 1F and FIGS. 2A to 2D, manufacturing of a first embodiment of an organic EL device according to the present invention is illustrated. An organic EL device of the illustrated embodiment is ultimately constructed in such a manner as shown in FIG. 2D. First of all, a general structure of the organic EL device of the illustrated embodiment will be briefly described with reference to FIG. 2D. The organic EL device includes a transparent insulating substrate 1, which is formed on a front surface thereof with a first wiring pattern. The first wiring pattern includes at least one first elongated electrode formed of a transparent electrode material. In the illustrated embodiment, the first wiring pattern is constituted of a plurality of first elongated electrodes 3 arranged on the front surface of the insulating substrate 1 in a manner to be spaced from each other at predetermined intervals while being juxtaposed to each other. The first electrodes 3 each are formed thereon with at least one luminous section 5. In the illustrated embodiment, each of the first electrodes 3 includes a plurality of luminous sections 5, which are made of an organic EL material and arranged so as to be spaced from each other in a direction in which the first electrode 3 extend. The luminous sections 5, as described below, each are formed by etching and configured into a substantially rectangular shape in plan. In the illustrated embodiment, the luminous sections 5 are formed into a substantially square shape. The luminous sections 5 each are formed on an upper surface of the first electrode 3 so as to leave an annular upper surface portion 3a on the first electrode 3 which is not covered with the luminous section 5, resulting in being arranged as if it is rectangularly surrounded with the annular upper surface portion 3a of the first electrode 3. The luminous sections 5 each are formed on an upper surface thereof with at least one second electrode 7, which is formed into a rectangular shape similar to the luminous section 5 and a size smaller than the luminous section 5. The second electrode 7 is formed on the upper surface of each of the luminous sections 5 so as to leave an annular upper surface portion 5a on the luminous section 5 which is not covered with the second electrode 7, resulting in being arranged as if it is rectangularly surrounded with the annular upper surface portion 5a of the luminous section 5.

Each of the luminous sections 5 and the second electrode 7 corresponding thereto are commonly formed on a periphery thereof with an annular insulating side wall structure 13, which is constituted by a first insulating side wall 9 made of an insulating material and a second insulating side wall 11 likewise made of an insulating material. The first insulating side wall 9 is formed into an annular shape so as to cover an outer peripheral side surface of the second electrode 7 and the annular upper surface portion 5a of the luminous section 5. The second insulating side wall 11 is formed into an annular shape so as to cover an outer peripheral side surface of the first electrode 9 and the annular upper surface portion 3a of the first electrode 3.

Reference numeral 15 designates an insulating protective layer made of an insulating material. The insulating protective layer 15 is formed with a plurality of holes 17 which permit an upper surface portions 7a of the second electrodes 7 to be exposed therethrough, respectively. The insulating protective layer 15 is arranged on the front surface of the insulating substrate 1 so as to cover each of the insulating side wall structures 13 and an exposed portion of each of the first electrodes 3 which is not covered with the insulating side wall structure 13. The insulating protective layer 15 is formed thereon with a second wiring pattern constituted of at least one third electrode 19. In the illustrated embodiment, the second wiring pattern is constituted by a plurality of the third electrodes 19 respectively connected through the holes 17 of the insulating protective layer 15 to the second electrodes 7. The third electrodes 19 are arranged so as to extend in a direction perpendicular to the first electrodes 3 while being spaced from each other at predetermined intervals and juxtaposed to each other.

Now, manufacturing of the organic EL device thus constructed will be described with reference to FIGS. 1A to 2D.

The insulating substrate 1 is made of a transparent insulating material such as glass, quartz, resin or the like. The insulating substrate 1, as shown in FIG. 1A, is formed on one surface thereof or a front surface thereof with a first electrode material layer 2, which is made of a transparent electrode material such as indium tin oxide (ITO) or the like. The first electrode material layer 2 is formed into a thickness as small as about 1 μm. The first electrodes 3 described above are made of the first electrode material layer 2. The first electrodes 3 are formed into a width of about 400 μm and arranged in juxtaposition to each other while being spaced from each other at intervals of tens to hundreds of micrometers.

The first electrode material layer 2 is provided on a front surface thereof with a luminous material layer 4 in the form of a thin film, which is made of an organic EL material. The luminous material layer 4 is constituted by, for example, a hole transport material layer of about 500 Å in thickness and an electron transport material layer of about 500 Å in thickness which are laminated on each other. Materials for the hole transport material layer of the luminous material layer 4 include triphenyl amine derivatives (TPD), hydrazone derivatives, aryl amine derivatives and the like. Materials for the electron transport material layer include aluminum quinoline derivatives (Alg₃), distyryl biphenyl derivatives (DPVBi), oxadiazole derivatives, bistyryl anthracene derivatives, benzoxazole thiophene derivatives, perylenes, thiazoles and the like. Alternatively, the luminous material layer 4 may be formed of a mixture obtained by mixing the hole transport material with a suitable luminous material. The luminous material layer 4 may be made of a mixture of the hole transport material and electron transport material. In this instance, the hole transport material and electron transport material may be mixed with each other at a ratio of between 10:90 and 90:10.

A variety of materials over 1000 different kinds which are used for the luminous material layer 4 are known in the art. In view of properties of the materials, the materials include a material having a hole transport capability, that having an electron transport capability, that having a luminous capability, that having a bipolar capability or both a hole transport capability and an electron transport capability, that having both a luminous capability and an electron transport capability, that having both a luminous capability and a hole transport capability, that having both a bipolar capability and a luminous capability, and the like.

The luminous material layer 4 may be made in the form of a thin film by vacuum deposition of a low-molecular organic material, spin coating of a high-molecular material, casting of a high-molecular material, or the like. The vacuum deposition may provide a laminate constituted by a combination of a hole transport layer obtained by laminating a triphenyl amine derivative (TPD) layer and an aluminum quinolinol complex (Alq₃) layer on each other with a luminous layer (electron transport layer). The vacuum deposition also may provide a three-layer structure in which a luminous layer is interposedly arranged between a hole transport layer and an electron transport layer. Further, the vacuum deposition may provide a mixed-type single-layer structure wherein a hole transport layer, an electron transport layer, a luminous layer, a doped layer and the like are mixed together. Application of spin coating or casting to formation of the luminous layer may likewise provide substantially the same layer structures as in the vacuum deposition.

The luminous material layer 4 is formed on a front surface thereof with a plurality of the above-described second electrodes 7, which may be made of, for example, Al-Li alloy of about 99% in purity containing 0.01 to 0.05% of Li. The second electrodes 7 each are formed into a thickness of about 2000 Å. Also, the second electrodes 7 each are formed into a rectangular shape in plan. In the illustrated embodiment, they are formed into a substantially square shape. The second electrodes 7 are made by mask deposition. More particularly, the luminous material layer 4 is covered at a portion thereof on which the second electrodes 18 are not provided with a mask. Then, the portion of the luminous material layer 4 is subject to deposition in a vertical direction. Intervals between the second electrodes 18 arranged adjacently to each other are set to be about 30 μm.

Then, the luminous material layer 4, as shown in FIG. 1B, is formed thereon with a first insulating material layer 8 so as to cover the second electrodes 7. The first insulating material layer 8 is desirably formed into a dense film which can be formed at a low temperature, in view of the fact that the luminous material layer 4 is made of an organic material. The first insulating material may be simply and conveniently formed by deposition, sputtering or the like. Alternatively, it may be formed by electron cyclotron resonance chemical vapor phase growth (ECR-CVD) or optical CVD. Materials for the first insulating material layer 8 include those exhibiting insulating properties or semi-insulating properties such as SiOx, SiN, GeOx, Al₂O₃ and the like, whether or not they satisfy a stoichiometric composition.

Then, as shown in FIG. 1C, the first insulating material layer 8 is removed for leaving the first annular insulating side wall in a manner to surround each of the second electrodes 7. The first insulating side wall 9 is formed into a thickness less than 0.1 μm. Such removal of the first insulating material layer 8 may be carried out by reactive ion etching (RIE). For example, when the first insulating material layer 8 is made of SiO₂, the reactive ion etching may be carried out using various kinds of gas including elemental gas such as CF₄, CHF₃, SF₆, NF₃ or CBrF₃, a mixture of the elemental gas with H2, He or O2, and the like. The reactive ion etching preferably takes place under a reduced pressure.

The reactive ion etching should be carried out so as not to cause dielectric breakdown of the luminous material layer 4 due to charge-up during the etching. Such dielectric breakdown is effectively prevented by removing the first insulating material layer 8 so as to leave the first annular insulating side wall 9 by reactive ion beam etching (RIBE) using gas decomposition due to electron cycloton resonance or the like.

A thickness of the first insulating material layer 8 and a configuration thereof prior to the etching are essential to satisfactory formation of the first insulating side wall 9. More specifically, it is required that the thickness and the configuration prior to the etching are selected so as to form a protrusion of an increased size on a portion of the first insulating material layer 8 on which the first insulating side wall 9 is formed. Also, satisfactory formation of the first insulating side wall 9 depends on a thickness of the second electrode 7 as well. An excessive decrease in thickness of the second electrode 7 fails to leave the first insulating side wall 9, whereas an excessive increase in thickness of the second electrode 7 to a degree sufficient to flatten the first insulating layer 8 likewise fails to leave the first insulating side wall 9. Thus, the second electrode 7 should be formed into an optimum thickness.

Subsequently, the luminous material layer 4 is subject to etching as shown in FIG. 1D. The etching may be carried out using such gas as used in the above-described etching of the first insulating layer 8. However, when the luminous material layer 4 is made of an organic material, O₂ plasma etching is particularly preferably carried out. In the O₂ plasma etching, attention should be paid to etching progressing so as to ensure that the etching intrudes into a non-luminous section positioned below the first insulating side wall 9. When a width of the first insulating side wall 9 is excessively reduced, the etching progresses to cause a gap to be formed below the second electrode 7. A width of the first insulating side wall 9 should be determined in view of such a situation.

Then, as shown in FIG. 1E, a second insulating material layer 10 which is made of an insulating material is arranged so as to cover an outer peripheral side surface of each of the second electrode 7, first insulating side wall 9 and luminous section 5. The second insulating material layer 10 may be formed of substantially the same material as the first insulating material layer 8 in substantially the same manner as the layer 8. Then, as shown in FIG. 1F, the upper surface portion. 7a of the second electrode 7 is exposed, resulting in the second insulating material layer 10 being removed at a part thereof by etching so as to leave the second annular insulating side wall 11 which surrounds an outer peripheral side surface of each of the first insulating side wall 9 and luminous section 5. Such removal of the second insulating layer material layer 10 is carried out by reactive ion etching (RIE) or the like as in the above-described removal of the first insulating side wall 8.

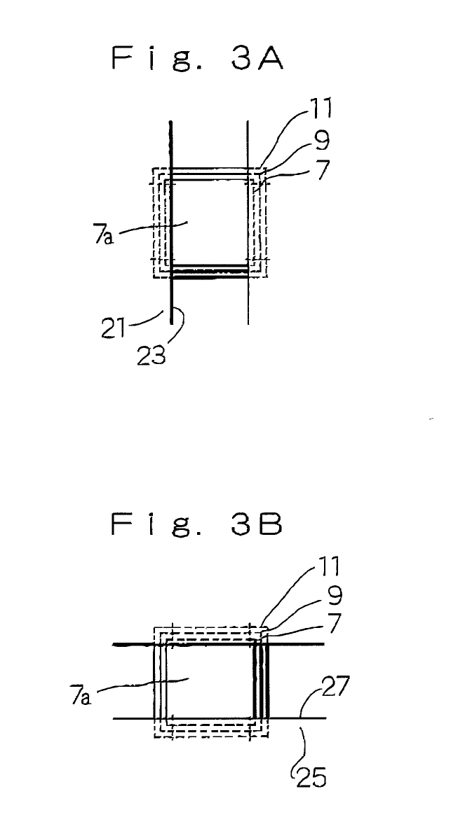

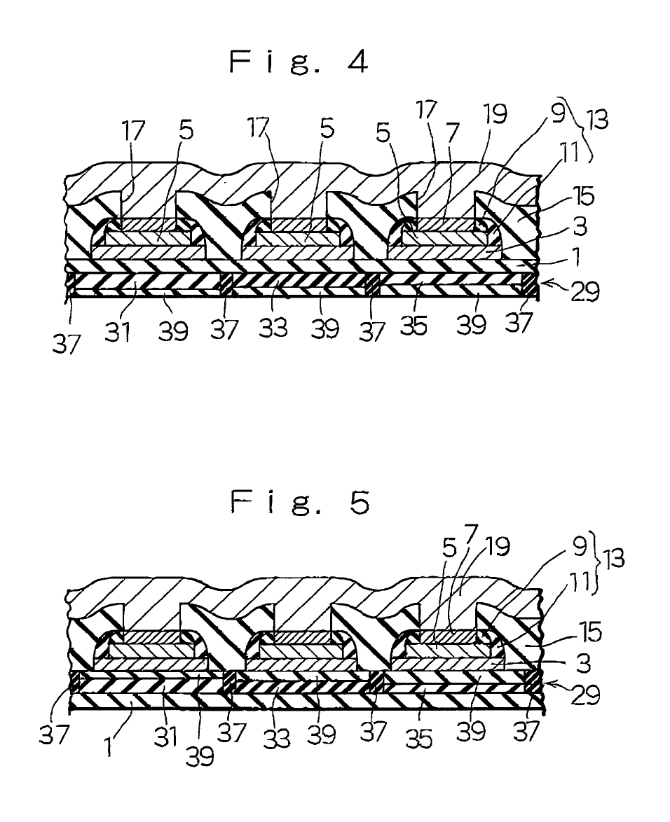

Thereafter, steps shown in FIGS. 2A to 2D are executed using photomasks 21 and 25 respectively shown in FIGS. 3A and 3B. The photomask 21, as shown in FIG. 3A, is formed with slits 23 used for formation of the first electrode 3. The photomask 25, as shown in FIG. 3B, is formed with slits 27 for formation of the third electrode 19. The slits 23 and 27 each are formed into a width slightly smaller than that of the second electrode 7.

First of all, each of the first electrodes 3 is subject to working or processing as shown in FIG. 2A. For this purpose, an ultraviolet-curing positive-type resist is coated all over the first electrode 3 and then irradiated with ultraviolet rays through the slits 23 of the photomask 21 of FIG. 3A, resulting in resin in the slits 23 being cured. Then, a photolithography step is carried out, wherein the resist is immersed in an etching liquid such as acetone or the like, so that a portion of the first electrode material layer 2 corresponding to an uncured portion of the resist may be removed. The slits 23 are formed into a width smaller than one side of the second electrode 7, so that an exposed portion of the first electrode 3 fully contiguous to a portion of the first electrode 3 positioned opposite to the second electrode 7 may be formed while substantially affecting accuracy at which the photomask 21 is positionally registered, to thereby prevent an increase in whole resistance of the first electrode 3. During patterning of the first electrode 21, the second electrode 7 is kept partially exposed without being covered with the photoresist. However, when the first electrode 3 is made of indium tin oxide (ITO) and the second electrode 7 is made of Al, selection of a suitable etching liquid keeps the second electrode 7 from being substantially etched.

Then, a third insulating material layer 14 is formed on the second electrodes 7 so as to cover the upper surface portion 7a of each of the second electrodes 7, as shown in FIG. 2B. The third insulating material layer 14 is preferably formed of ultraviolet-curing resin which does not require any heating. Formation of the third insulating material layer 14 using ultraviolet-curing resin permits each of the holes 17 to be formed at a position corresponding to the upper surface portion 7a of each of the second electrodes 7 using the photomask. Formation of the holes 17 is facilitated by carrying out back-exposure from a rear surface of the insulating substrate 1 to render resin on the second electrode 7 uncured using the second electrode 7 as a mask and then removing the uncured resin by means of a suitable solvent. This results in providing the insulating protective layer 15 formed with the holes 17 through which the upper surface portion 7a of each of the second electrodes 7 is exposed.

Then, a second wiring pattern constituted by the third electrodes 19 is formed on the insulating protective layer 15. The third electrodes 19 each may be provided by forming Al or the like into a conductive material layer by deposition and then subjecting it to lithography as in the first electrodes 3. The slit 25 of the photomask 27 used for formation of the third electrodes 19 by lithography is formed into a width smaller than one side of the second electrode 7. This prevents a reduction in area thereof contacted with the second electrode 7.

Now, use of the thus-constructed organic EL device of the illustrated embodiment for color display will be described with reference to FIG. 4, which shows a combination of a color filter 29 or a color conversion layer with the organic EL device shown in FIG. 2D. The color filter 29 includes plural sets of three kinds of wavelength conversion sections 31, 33 and 35 for red, green and blue which are arranged in a manner to correspond to the luminous sections 5 and constructed so as to convert incident light of a predetermined wavelength intensity distributions emitted from the luminous sections 5 into three primary colors or colors similar thereto. The wavelength conversion sections 31, 33 and 35 are partitioned from each other by black lattice layers 37. Reference numeral 39 designates a light-permeable or transparent flattened layer arranged so as to correct a difference in thickness among the wavelength conversion sections 31, 33 and 35. The flattened layer 39 may be made of polyimide or the like.

The color filter 29 may be arranged between the insulating substrate 1 and the first electrodes 3 as shown in CCC FIG. 5. Such construction may be obtained by replacing the insulating substrate 1 with a substrate made of resin soluble in an organic solvent. Then, the substrate is removed by an organic solvent, to thereby provide a device free of the transparent insulating substrate 1. Then, the color filter 29 is interposedly bonded between the thus-obtained device and the insulating substrate 1. The bonding may be carried out using a transparent adhesive or the like. The adhesive is preferably ultraviolet-curing.

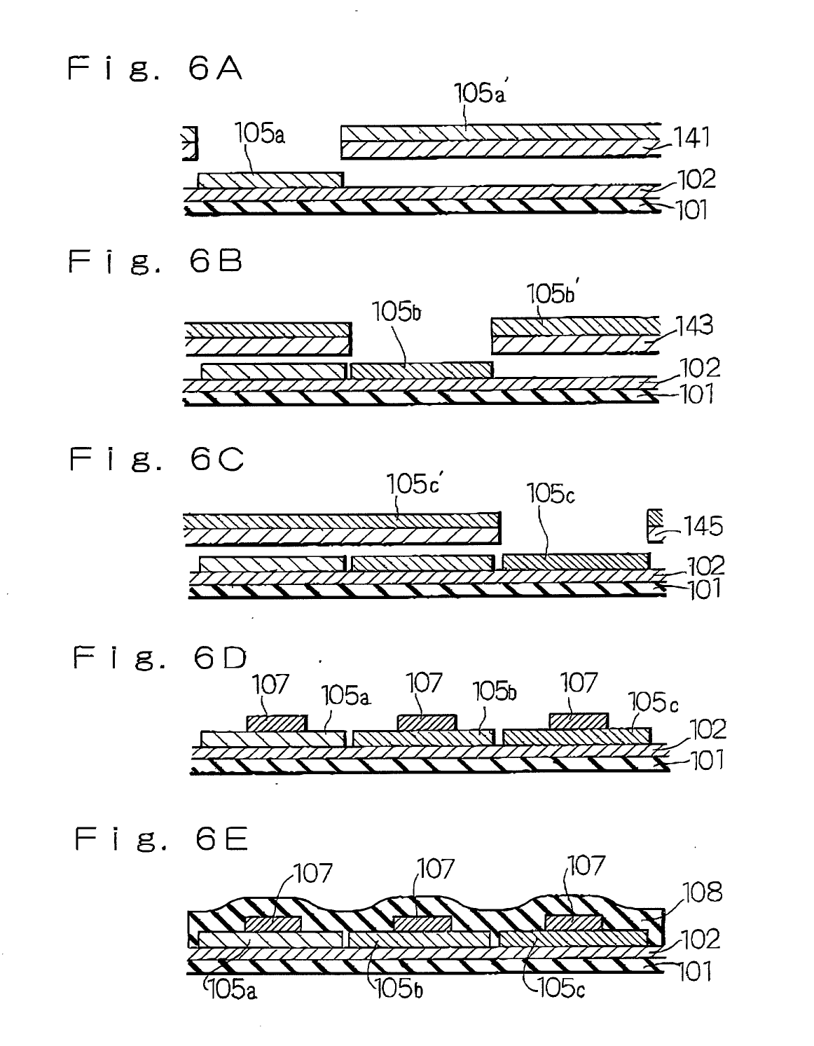

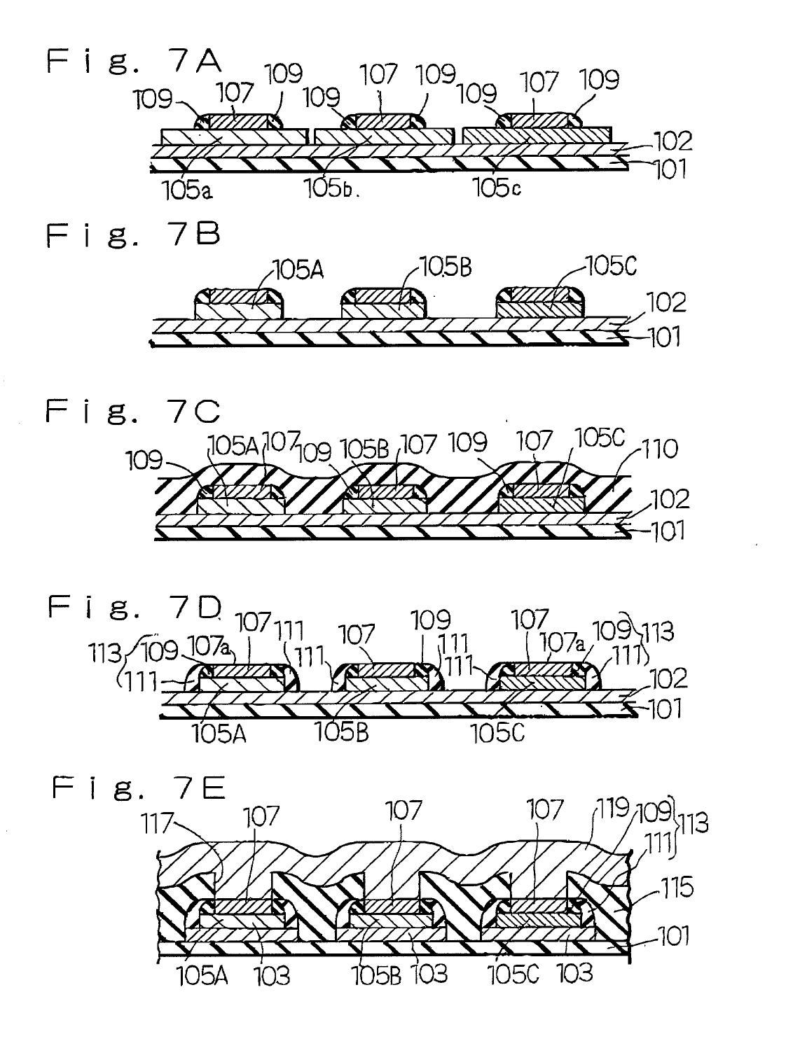

Referring now to FIGS. 6A to 6E and FIGS. 7A to 7E, another embodiment of an organic EL device according to the present invention is illustrated which includes three kinds of luminous sections emitting the three primary colors or colors similar thereto. The organic EL device ultimately has a structure shown in FIG. 7E. In FIGS. 6 and 7, reference numerals correspond to the reference numerals discussed with reference to FIGS. 1 and 2D, except with an additional prefix of 100. The organic EL device is different from that shown in FIGS. 1 and 2D in that the former includes a plurality of sets of three kinds of luminous sections 105A, 105B and 105C emitting the three primary colors or colors similar thereto. More particularly, a first group of plural first electrodes 103 includes two first electrodes intermediately arranged and is formed thereon with a plurality of the luminous sections 105A, which are constructed so as to emit one of the three primary colors. A second group of plural first electrodes 103 includes two first electrodes intermediately arranged and is formed thereon with a plurality of the luminous sections 1051, which are constructed so as to emit another one of the three primary colors. Also, a third group of plural first electrodes 103 includes two first electrodes intermediately arranged and is formed thereon with a plurality of the luminous sections 105C, which are constructed so as to emit the other one of the three primary colors. The remaining part of the illustrated embodiment may be constructed in substantially the same manner as the embodiment described above with reference to FIGS. 1 and 2.

Now, manufacturing of the thus-constructed organic EL device of the illustrated embodiment will be described hereinafter with reference to FIGS. 6A to 7E.

First of all, as shown in FIGS. 6A to 6C, a first electrode material layer 102 is provided on a front surface thereof with deposition masks 141, 142 and 143 in order, to thereby form a plurality of luminous thin film layers 105a, 105b and 105c for emitting one of the three primary colors. At this time, the deposition masks 141, 142 and 143 have deposition layers 105a′, 105b′ and 105c′ corresponding to the luminous thin film layers 105a, 105b, and 105c deposited on a front surface thereof, respectively. The luminous thin film layers 105a, 105b and 105c are formed into a size larger than that of the luminous sections 105A, 105B and 105C described above. Then, a plurality of second electrodes 107 are formed on each of the luminous thin film layers 105a to 105c in a manner to be positioned on a central portion thereof. Then, a first insulating material layer 108 is formed on the second electrodes 107 as shown in FIG. 6E, followed by removal of the first insulating material layer 108 so as to leave first insulating side walls each surrounding an outer peripheral side surface of each of the second electrodes 107 as shown in FIG. 7A. Subsequently, as shown in FIG. 7B, luminous sections 105A to 105C are formed by plasma etching. Then, a second insulating material layer 110 is formed of an insulating material so as to surround an outer peripheral side surface of each of the second electrodes 107, first insulating side walls 109 and luminous sections 105A to 105C, followed by exposure of an upper surface portion 107a. of the second electrodes 107 as shown in FIG. 7D. Thereafter, the second insulating material layer 110 is partially removed by etching, resulting in leaving a second insulating side wall 111 surrounding the outer peripheral side surface of each of the first insulating side walls 109 and luminous sections 105A to 105C. Then, the first electrode material layer 102 is subject to etching by photolithography, to thereby provide a plurality of the first electrodes 103. Then, substantially the same steps as those shown in FIGS. 2B and 2C are carried out to provide an insulating protective layer 115 formed with holes 117, followed by formation of a plurality of third electrodes 119, resulting in the color organic EL device shown in FIG. 7E being provided.

In the organic EL device of the present invention, formation of the second electrodes is carried out using Al. Alternatively, it may be executed using any suitable metal other Al. Also, the luminous material layer for the luminous sections may be formed using any suitable vacuum thin film deposition techniques other than deposition such as sputtering or the like. Further, the first electrodes may be individually formed. In this instance, the transparent electrode pattern is formed on the transparent insulating substrate, resulting in being electrically connected to the first electrodes.

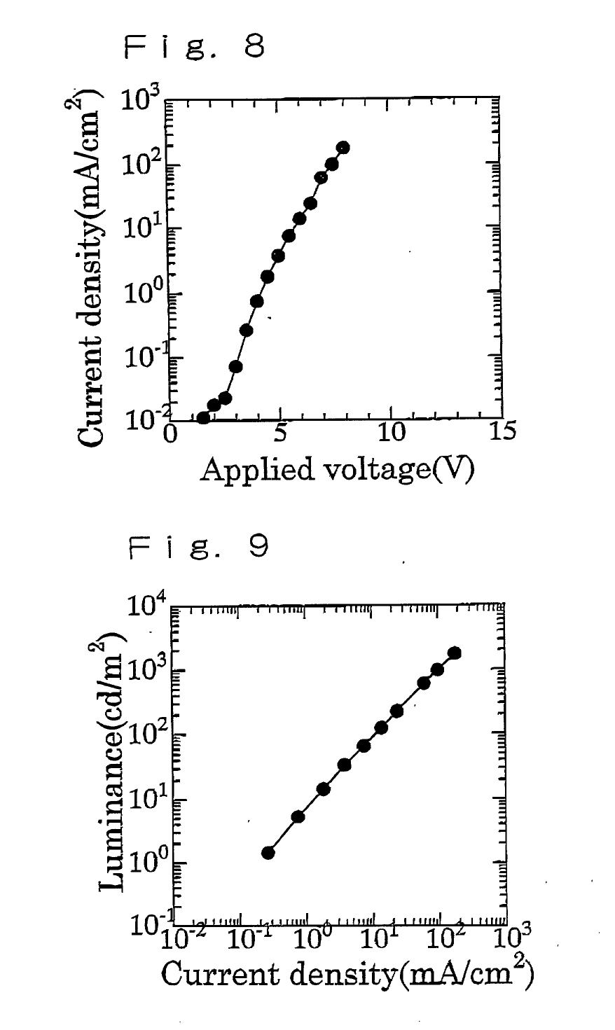

The organic EL device of the present invention actually manufactured exhibits such characteristics as shown in FIGS. 8 and 9 by way of example. The organic EL device manufactured is constructed in such a manner as shown in FIG. 2D, wherein the first electrodes each are made of ITO, the luminous material layer is formed of TPD of 500 Å in thickness and Alq₃ of 500 Å in thickness, and the second electrodes each are made of Al-Li. alloy. FIG. 8 shows current-voltage characteristics of the organic EL device and FIG. 9 shows luminescence-current characteristics thereof. FIG. 8 indicates that although the organic EL device somewhat causes leakage of a current on a low voltage side, it exhibits satisfactory current-voltage characteristics increased in rising of a current from the low voltage side toward a high voltage side. FIG. 9 indicates that the organic EL device exhibits luminescence-current characteristics of substantially the same level as a conventional organic EL device. Luminescence is carried out at a voltage of 3.5 V or more and uniform throughout the device.

As can be seen from the foregoing, the organic EL device of the present invention permits the luminous sections to individually accurately emit light for every luminous unit and provides luminescence at increased quality while eliminating leakage of a current from each of the luminous sections to those adjacent thereto.

While preferred embodiments of the invention have been described with a certain degree of particularity with reference to the drawings, obvious modifications and variations are possible in light of the above teachings. It is therefore to be understood that within the scope of the appended claims, the invention may be practiced otherwise than as specifically described.

What is claimed is:

1. An organic EL device comprising:
at least one first electrode made of a transparent electrode material;
at least one luminous section made of an organic EL material and formed on said first electrode so that said first electrode has an annular upper surface portion which is not covered with said luminous section left on an upper surface thereof in a manner to surround said luminous section;
at least one second electrode formed on said luminous section so that said luminous section has an annular upper surface portion which is not covered with said second electrode left on an upper surface thereof in a manner to surround said second electrode;
at least one insulating side wall structure made of an insulating material, formed into an annular shape and arranged so as to cover said annular upper surface portion of said first electrode, an outer peripheral side surface of said luminous section, said annular upper surface portion of said luminous section and an outer peripheral side surface of said second electrode;
an insulating protective layer made of an insulating material so as to cover said insulating side wall structure and an exposed portion of said first electrode and provided with at least one hole through which an upper surface portion of said second electrode is exposed; and
at least one third electrode formed on said insulating protective layer and connected to said second electrode through said hole.

2. An organic EL device as defined in claim 1, wherein said insulating side wall structure includes a first insulating side wall arranged so as to cover said outer peripheral side surface of said second electrode and said annular upper surface portion of said luminous section and a second insulating side wall arranged so as to cover an outer peripheral side surface of said first insulating side wall and said annular upper surface portion of said first electrode.

3. An organic EL device comprising:
a transparent insulating substrate,
a first wiring pattern constituted of a plurality of first electrodes formed of a transparent electrode material and arranged on a front surface of said insulating substrate in a manner to be spaced from each other at predetermined intervals while being juxtaposed to each other;
a plurality of luminous sections formed of an organic EL material and arranged on each of said first electrodes in a manner to be spaced from each other at predetermined intervals in a direction in which said first electrode extends;
said luminous sections each being formed by etching and arranged so that said first electrodes each have an annular upper surface portion which is not covered with said luminous section left on an upper surface thereof in a manner to surround said luminous section;
a plurality of second electrodes each formed on each of said luminous sections and arranged so that said luminous sections each have an annular upper surface portion which is not covered with each of said second electrodes left on an upper surface thereof in a manner to surround each of said second electrode;
a plurality of insulating side wall structures each made of an insulating material, formed into an annular shape and arranged so as to cover said annular upper surface portion of each of said first electrodes, an outer peripheral side surface of each of said luminous sections, said annular upper surface portion of each of said luminous sections and an outer peripheral side surface of each of said second electrodes;
an insulating protective layer formed of an insulating material so as to cover said insulating side wall structures and an exposed portion of said first electrodes and provided with holes through which an upper surface portion of said second electrodes is exposed; and
a second wiring pattern formed on said insulating protective layer and connected to said second electrodes through said holes of said insulating protective layer.

4. An organic EL device as defined in claim 3, wherein said second wiring pattern is constituted of a plurality of third electrodes arranged so as to intersect said first electrodes of said first wiring pattern and juxtaposed to each other while being spaced from each other at predetermined intervals.

5. An organic EL device as defined in claim 3, wherein said first wiring pattern is formed by etching; and
said insulating side wall structures each include a first insulating side wall arranged so as to cover said outer peripheral side surface of each of said second electrodes and said annular upper surface portion of each of said luminous sections and a second insulating side wall arranged so as to cover an outer peripheral side surface of said first insulating side wall and said annular upper surface portion of each of said first electrodes.

6. An organic EL device as defined in any one of claims 3 to 5, further comprising a color filter arranged on a rear surface of said insulating substrate;
said color filter including a plurality of wavelength conversion sections arranged in a manner to correspond to said luminous sections and constructed so as to convert incident light of predetermined luminous wavelength intensity distributions emitted from said luminous sections into the three primary colors or colors similar thereto.

7. An organic EL device as defined in any one of claims 3 to 5, further comprising a color filter arranged between said front surface of said insulating substrate and said first wiring pattern;
said color filter including a plurality of wavelength conversion sections arranged in a manner to correspond to said luminous sections and constructed so as to convert incident light of predetermined luminous wavelength intensity distributions emitted from said luminous sections into the three primary colors or colors similar thereto.

8. An organic EL device as defined in claim 3, wherein said first electrodes are classified into first to third groups;
said first group of first electrodes including two first electrodes intermediately arranged and being formed thereon with a plurality of said luminous sections, which are constructed so as to emit one of the three primary colors;
said second group of first electrodes including two first electrodes intermediately arranged and being formed thereon with a plurality of said luminous sections, which are constructed so as to emit another one of the three primary colors:
said third group of first electrodes including two first electrodes intermediately arranged and being formed thereon with a plurality of said luminous sections, which are constructed so as to emit another the other one of the three primary colors,

9. A method for manufacturing an organic EL device, comprising the steps of:
forming a first electrode layer for a plurality of first electrodes on a front surface of a transparent insulating substrate, said first electrode layer being made of a transparent electrode material;
forming a luminous material layer on said first electrode material layer, said luminous layer being made of an organic EL material;
forming a plurality of second electrodes of a predetermined configuration on said luminous material layer while spacing said second electrodes from each other at predetermined intervals;
forming a first insulating material layer on said luminous material layer so as to cover said second electrodes, said first insulating material being made of an insulating material;
removing said insulating material layer so as to leave a plurality of first insulating side walls surrounding an outer peripheral side surface of said second electrodes;
subjecting said luminous material layer to etching so as to leave a plurality of luminous sections below said second electrodes and first insulating side walls;
forming a second insulating material layer so as to cover said second electrodes, first insulating side walls and luminous sections, said second insulating material layer being made of an insulating material;
removing said second insulating material layer so as to expose an upper surface of each of said second electrodes and leave a plurality of second insulating side walls surrounding an outer peripheral surface of each of said first insulating side walls and an outer peripheral side surface of each of said luminous sections;
subjecting said first electrode material layer to etching so as to form a first wiring pattern constituted of a plurality of the first electrodes juxtaposed to each other below said luminous sections and second insulating side walls;
forming an insulating protective layer on said front surface of said insulating substrate;
said insulating protective layer being made of an insulating material and formed with a plurality of holes through which said upper surface of said second electrodes is exposed; and
forming a second wiring pattern on said insulating protective layer in a manner to connect said second wiring pattern to said second electrodes through said holes of said insulating protective layer.
